(19) United States
(12) Patent Application Publication
(10) Pub. No.: US 2024/0078538 A1
(43) Pub. Date: Mar. 7, 2024

(54) COMPUTER-IMPLEMENTED SYSTEM AND METHOD FOR PERFORMING TRANSACTION MIXING ON A BLOCKCHAIN

(71) Applicant: nChain Licensing AG, Zug (CH)

(72) Inventors: Daniel JOSEPH, London (GB); Craig Steven WRIGHT, London (GB)

(21) Appl. No.: 18/240,339

(22) Filed: Aug. 30, 2023

Related U.S. Application Data
(63) Continuation of application No. 16/606,203, filed on Oct. 17, 2019, now Pat. No. 11,783,321.

(30) Foreign Application Priority Data
Apr. 18, 2017 (GB) 1706071.6

(51) Int. Cl. G06Q 20/36; G06Q 20/06; G06Q 20/40; H04L 9/06

(52) U.S. Cl. CPC G06Q 20/3678; G06Q 20/0658; G06Q 20/3674; G06Q 20/405; H04L 9/0637

(57) ABSTRACT

A system is provided for performing transaction mixing between a plurality of users on a blockchain. The system is configured to carry out the steps of: selecting an initiator node to calculate a deterministic hash function using a chosen random number; distribute the deterministic hash function to a plurality of users on the blockchain; choose an amount of time each user is given to construct a payment channel, retrieve the random number, and submit an execution transaction to a blockchain network; choose a second time for when a payment to a user is submitted to the blockchain network; and establish a one-way payment channel between every pair of users in an ordered set of the plurality of users to establish a transaction chain linking all users.

### CROSS REFERENCE TO RELATED APPLICATIONS

This application is a continuation of U.S. patent application Ser. No. 16/606,203, filed Oct. 17, 2019, entitled “COMPUTER-IMPLEMENTED SYSTEM AND METHOD FOR PERFORMING TRANSACTION MIXING ON A BLOCKCHAIN,” which is a 371 National Stage of International Patent Application No. PCT/IB2018/052530, filed Apr. 11, 2018, which claims priority to United Kingdom Patent Application No. 1706071.6, filed Apr. 18, 2017, the disclosures of which are incorporated herein by reference in their entirety.

### FIELD OF INVENTION

This invention relates generally to blockchain transactions, and more particularly to the exchange of blockchain transactions within a group containing three or more users. The invention is particularly suited, but not limited, to use with the Bitcoin (BTC) blockchain.

### BACKGROUND OF INVENTION

In this document we use the term ‘blockchain’ to include all forms of electronic, computer-based, distributed ledgers. These include consensus-based blockchain and transaction-chain technologies, permissioned and un-permissioned ledgers, shared ledgers and variations thereof. The most widely known application of blockchain technology is the Bitcoin ledger, although other blockchain implementations have been proposed and developed. While Bitcoin may be referred to herein for the purpose of convenience and illustration, it should be noted that the invention is not limited to use with the Bitcoin blockchain and alternative blockchain implementations and protocols fall within the scope of the present invention.

A blockchain is a peer-to-peer, electronic ledger which is implemented as a computer-based decentralised, distributed system made up of blocks which in turn are made up of transactions. Each transaction is a data structure that encodes the transfer of control of a digital asset between users in the blockchain system, and includes at least one input and at least one output. Each block contains a hash of the previous block and the blocks become chained together to create a permanent, unalterable record of all transactions which have been written to the blockchain since its inception. Transactions contain small programs known as scripts embedded into their inputs and outputs, which specify how and by whom the outputs of the transactions can be accessed. On the Bitcoin platform, these scripts are written using a stack-based scripting language.

In order for a transaction to be written to the blockchain, it must be “validated”. Network nodes (miners) perform work to ensure that each transaction is valid, with invalid transactions rejected from the network. Software clients installed on the nodes perform this validation work on an unspent transaction (UTXO) by executing its locking and unlocking scripts. If execution of the locking and unlocking scripts evaluate to TRUE, the transaction is valid and the transaction is written to the blockchain. Thus, in order for a transaction to be written to the blockchain, it must be: i) validated by the first node that receives the transaction—if the transaction is validated, the node relays it to the other nodes in the network; ii) added to a new block built by a miner; and iii) mined, i.e. added to the public ledger of past transactions.

Although blockchain technology is most widely known for the use of cryptocurrency implementation, digital entrepreneurs have begun exploring the use of both the cryptographic security system Bitcoin is based on and the data that can be stored on the Blockchain to implement new systems. It would be highly advantageous if the blockchain could be used for automated tasks and processes which are not limited to the realm of cryptocurrency. Such solutions would be able to harness the benefits of the blockchain (e.g. a permanent, tamper proof records of events, distributed processing etc) while being more versatile in their applications.

One area of current research is the use of the blockchain for the implementation of “smart contracts.” These are computer programs designed to automate the execution of the terms of a machine-readable contract or agreement. Unlike a traditional contract which would be written in natural language, a smart contract is a machine executable program which comprises rules that can process inputs in order to produce results, which can then cause actions to be performed dependent upon those results.

Another area of blockchain-related interest is the use of ‘tokens’ (or ‘coloured coins’) to represent and transfer real-world entities via the blockchain. A potentially sensitive or secret item can be represented by the token which has no discernible meaning or value. The token thus serves as an identifier that allows the real-world item to be referenced from the blockchain.

Blockchains which provide an open, public ledger make available to any interested parties the ability to trace the movement of specific digital coins, digital assets, or control of digital resources across a sequence of addresses. For example, Bitcoin's effectiveness and success as a currency is tied to the real and perceived fungibility of bitcoins, fungibility being the interchangeability property of a unit of a good with other unit goods of the same type (http://www.investopedia.com/terms/f/fungibility.asp). While the ledger being open and distributed is useful in acting as a means to trust the system, the ability it gives for tracking transactions across addresses allows for digital assets related to specific historical transactions to be analysed and correlated. To address Bitcoin fungibility, security and anonymization solutions have been developed. This can be useful as many real-world commercial transactions are confidential in nature, either for legal reasons, commercial reasons, or both. Accordingly, blockchain systems must be capable of ensuring both security and confidentiality for such commercial transactions despite the public nature of the blockchain.

Research in Bitcoin anonymity has included the development of alt-coins such as ZeroCash (Ben-Sasson, E., et al. (2014), “Zerocash: Decentralized Anonymous Payments from . . . ,” http://zerocash-project.org/media/pdf/zerocash-oakland2014.pdf) and Monero (Mackenzie, A., Noether, S., et al. (2015), “Improving Obfuscation in . . . ,” https://lab.getmonero.org/pubs/MRL-0004.pdf′). Likewise, Bitcoin-compatible solutions have been developed. Of these compatible solutions, coin mixing and associated variations are the most common, however other inventive anonymisation techniques exist, such as TumbleBit (Heilman, E., Alshenibr, L., Baldimtsi, F., Scafuro, A. and Goldberg, S., 2016. TumbleBit: An untrusted Bitcoin-compatible anonymous payment hub. Cryptology ePrint Archive, Report 2016/575; https://eprint.iacr.org/2016/575.pdf) and the use of Stealth Addresses (Franco, P., (2014), “Understanding Bitcoin: Cryptography . . . ,” http://eu.wiley.com/WileyCDA/WileyTitle/productCd-1119019168.html).” What all these solutions have in common are measures to disassociate users from specific Bitcoin transactions and addresses (where the user is either payer or where the user is the payee).

In the case of coin mixing solutions, the user inputs bitcoins into a service and their bitcoins are transferred to an output address of the user's choosing. The funds having being pooled before they are sent to the output addresses makes it difficult to ascertain which of the output addresses belongs to the user.

### SUMMARY OF INVENTION

The present inventors have identified several technical and security related problems with the blockchain transaction mixing approaches described in the background section. Such transaction mixing approaches require a mixing service provider. This introduces an additional resource requirement into the system and additional management overhead for provision of this centralized transaction mixing service provider. Furthermore, the provision of a central transaction mixing service provider dilutes or compromises the decentralized, peer-to-peer architecture of a blockchain system. Such a centralized system removes control from the users. Furthermore, such a centralized system provides a focal point in the system for attack. Further still, the transaction mixing service provider may steal a user's digital assets from the pool or reveal to external parties the links between input addresses and output addresses, either intentionally or unintentionally, thus reducing security and confidentiality. In many ways, the provision of a centralized transaction mixing service provider compromises the fundamental ethos of a decentralized, peer-to-peer blockchain system which is intended to negate the requirement for centralized bodies.

In light of the above, one technical problem to be solved may be how to provide a solution which enables blockchain transaction mixing to be achieved in a way which is more decentralized, secure, and confidential than existing solutions and which is controlled by users of the system rather than managed by a third party transaction mixing service provider in the manner of existing systems described in the background section.

Thus, in accordance with the invention, methods and systems are provided as defined in the appended claims.

The invention may provide a computer-implemented system. It may be described as a blockchain-implemented system, a security system and/or a control system.

Additionally or alternatively, the invention may provide a system for performing transaction mixing between a plurality of users on a blockchain, configured to carry out the steps of: (i) preparing a first commitment transaction arranged to transmit control of a resource from a source address of a first user to a receiving address of a second user; (ii) preparing a second commitment transaction arranged to transmit control of a resource from a source address of the second user to a receiving address of a further user; (iii) preparing a further commitment transaction arranged to transmit control of a resource from a source address of the further user to either: (a) a receiving address of the first user; or (b) a receiving address of a yet further user and repeating step (iii) until option (a) is performed to complete a transaction chain; and executing the transaction chain, wherein at least one of the users is randomly chosen from the plurality.

The term “user” may refer to a human or a processor-based resource.

By providing such a system, a plurality of users are enabled to construct a transaction channel enabling exchange of resources with increased security and confidentiality. The transaction mixing system is distinct in forming and executing a blockchain transaction chain with at least one of the users being randomly chosen from the plurality of users in the chain. The chain is set up using commitment transactions. Such a system for exchanging digital assets between a plurality of users is more secure and does not require additional system overheads when compared to the prior art configurations described in the background section. For example, the system does not require a mixing service provider which would otherwise introduce an additional resource requirement into the system and additional management overhead for provision of this centralized transaction mixing service provider. Furthermore, the provision of a central transaction mixing service provider dilutes or compromises the decentralized, peer-to-peer architecture of a blockchain system. Such a centralized system removes control from the users. Furthermore, such a centralized system provides a focal point in the system for attack. Further still, the transaction mixing service provider may steal a user's digital assets from the pool or reveal to external parties the links between input addresses and output addresses, either intentionally or unintentionally, thus reducing security. In contrast, in the present system preparing and executing the transactions via a chain of commitment transactions is performed by the users rather than a third party. That is, the system utilizes a protocol that is not implemented/controlled by a third party.

One technical effect of the invention results in a computer system which is made to operate in a new way. Furthermore, the computer system is a better computer system in the sense of running more efficiently and effectively to the extent that the system is more robust to hacking and data manipulation.

At least one commitment transaction may be arranged to transmit control of a respective resource responsive to satisfaction of an execution condition of the at least one commitment transaction.

This provides the advantage of increasing the speed at which at least a part of the transaction chain may be executed.

The system may be configured to carry out the step of preparing at least one execution transaction arranged to satisfy a respective execution condition.

This provides the advantage of further increasing the speed at which at least a part of the transaction chain may be executed.

The execution condition of the at least one commitment transaction may comprise the supply of a respective secret value.

This enables the transaction chain to be constructed without risk to a first user, while enabling a more secure subsequent execution of the transaction chain.

At least one secret value may be be chosen by the first user, and at least one execution condition may comprise the supply of the chosen secret value.

This provides the advantage of a simple way of increasing security for users.

At least one secret value may be calculable responsive to at least one of: (i) supply of the chosen secret value; and (ii) supply of at least one other secret value.

This provides the advantage of increasing the security of the system by enabling different secret values to be used without significantly increasing the time it takes to complete execution of the transaction chain.

At least one commitment transaction may be arranged to return control of a respective resource to a respective user upon satisfaction of a return condition.

This provides the advantage of increasing security against theft from a user of at least one resource.

The system may be configured to carry out the step of preparing at least one return transaction comprising a locktime, the at least one return transaction arranged to satisfy at least one respective return condition upon expiry of the locktime.

This provides the advantage of limiting the maximum amount of time allowed during use of the system, thereby reducing the amount of computer resources required.

The system may be configured to submit to a blockchain at least one prepared transaction.

This provides the advantage of preventing tampering of the at least one prepared transaction by storing it on the blockchain, thereby increasing security.

The system may be configured to execute the transaction chain in an order reverse to the order in which the transaction chain is prepared.

This enables a first user to initiate the execution of the chain of commitment transactions once complete, thereby increasing security by isolating risk to one user among a plurality.

The system of any preceding claim, wherein the resources are identical to one another.

This provides the advantage of simplifying the use of the system.

Additionally or alternatively, there may be provided a computer-implemented method for participating in transaction mixing between a plurality of users on a blockchain comprising the steps of: (i) submitting to a blockchain a first commitment transaction arranged to transmit control of a first resource from a source address of a first user to a receiving address of a second user upon satisfaction of an execution condition of the first commitment transaction; and (ii) responsive to submission to the blockchain of a second commitment transaction arranged to transmit control of a third resource from a source address of a third user to a receiving address of the first user, submitting to the blockchain an execution transaction arranged to satisfy an execution condition of the third commitment transaction, wherein at least one of the users is randomly chosen from the plurality.

Additionally or alternatively, there may be provided a computer-implemented method for participating in transaction mixing between a plurality of users on a blockchain comprising the steps of: (i) submitting to a blockchain a first commitment transaction arranged to transmit control of a resource from a source address of a first user to a receiving address of a second user upon satisfaction of a condition of the first commitment transaction; and (ii) responsive to submission to the blockchain of a first execution transaction arranged to satisfy a condition of the first commitment transaction, submitting to the blockchain a second execution transaction arranged to satisfy a condition of a second commitment transaction, wherein at least one of the users is randomly chosen from the plurality.

According to certain configurations, it may be desirable to enable at least one individual to move bitcoins from one of their addresses to another address in their possession in a manner that obscures the link between both addresses and which is achieved in a secure manner without requiring a centralized coin mixing service provider. This can be achieved by providing a system in which an individual participates in a group exchange protocol where each member pays another random member of the group x, or other negotiated amount of, bitcoins and another random member pays the user x, or other negotiated amount, bitcoins. The exchange protocol is designed in such a way that the user effectively moves his/her funds to a new address, and no member of the group exchange risks losing any of their bitcoins.

### BRIEF DESCRIPTION OF THE DRAWINGS

These and other aspects of the present invention will be apparent from and elucidated with reference to, the embodiments described herein. Embodiments of the present invention will now be described, by way of example only, and with reference to the accompany drawings, in which:

FIG. 1 shows the transactions used in a payment channel of the prior art;

FIG. 2 shows an Atomic Cross-Chain Trading algorithm of the prior art;

FIG. 3 shows a payment channel of a first embodiment of the present invention;

FIG. 4 illustrates an order in which payment channels of the present invention may be created;

FIG. 5 illustrates a chain of payment channels of the first embodiment;

FIG. 6 shows an example commitment transaction of the first embodiment;

FIG. 7 shows an example refund transaction of the first embodiment;

FIG. 8 shows an example payment transaction of the first embodiment;

FIG. 9 shows an algorithm for constructing the payment channel of FIG. 1;

FIG. 10 shows an algorithm for constructing a payment channel of the first embodiment;

FIG. 11 shows an algorithm for constructing a chain of payment channels of the first embodiment;

FIG. 12 shows an algorithm for the process of submitting payment transactions of the first embodiment;

FIG. 13 shows a payment channel of a second embodiment of the present invention;

FIG. 14 shows an algorithm for constructing a payment channel of the second embodiment;

FIG. 15 shows an algorithm for constructing a chain of payment channels of the second embodiment;

FIG. 16 illustrates a chain of payment channels of the second embodiment;

FIG. 17 shows a representation of execution of a chain of payment channels of the second embodiment;

FIG. 18 shows an algorithm for the process of submitting payment transactions of the second embodiment;

FIG. 19 illustrates a chain of payment channels of the second embodiment including refund transactions;

FIG. 20 illustrates locktime requirements for refund transactions of the second embodiment;

FIG. 21 shows an example commitment transaction of the second embodiment;

FIG. 22 shows an example refund transaction of the second embodiment;

FIG. 23 shows an example payment transaction of the second embodiment; and

FIG. 24 shows example scripts for use in the second embodiment.

### DETAILED DESCRIPTION

A protocol, named the Group Random Exchange (GRE) protocol embodying the present invention, is described herein for a user to move funds from one address to another while obscuring the link between the user's addresses and while removing the possibility of a user having his/her funds stolen. It is built on the concept of a group agreeing for each member of the group to pay x BTC to one other member such that everyone gets paid.

Who a user pays x BTC to is random and who pays the user x BTC is also random. By doing this the user may send his x BTC to one address but accept receipt of x BTC at a different address from a different user who is randomly determined. This randomness makes it difficult for someone external to the protocol to analyse the blockchain and determine a link between the user's input and output addresses.

Moreover, the GRE protocol is able to accomplish this exchange between a group of n users where no user within the group risks losing their funds. The protocol uses refund transactions, where applicable, to allow a user to reclaim their funds if anything does not go as planned in the execution of the protocol.

The GRE Protocol builds on two existing Bitcoin-related technologies. The first of these is Payment Channels (Introduction to Micropayment Channels' http://super3.org/introduction-to-micropayment-channels/), which is a technique designed for off-block bitcoin transactions between a pair of users and notably incorporates the usage of refund transactions. The second of these technologies is Atomic Cross-Chain Trading (ACCT) (Atomic cross-chain trading,′ https://en.bitcoin.it/wiki/Atomic_cross-chain_trading), which is a protocol designed for a user with x coins in one cryptocurrency to exchange them for another user's y coins in another cryptocurrency. This is done as a “fair exchange,” such that a first user cannot acquire a second user's coins without giving the second user the ability to collect the coins they are owed by the first user.

Whereas ACCT describes an exchange between two users, the present invention relates to the GRE protocol, which provides group exchange between more than two users where a second user who is paid by a first user is not the user who pays the first user.

Payment Channels

Payment channels are techniques designed for users to make multiple Bitcoin transactions without committing all of the transactions to the blockchain. In a typical payment channel implementation, a nearly unlimited amount of payments can be made but it is only ever necessary to add two transactions to the blockchain.

In addition to the reduced number of transactions being added to the blockchain and the associated reduced costs, payment channels also offer the advantage of speed and, importantly, the ability of the users to have their funds refunded if the things do not go as planned or either user decides not to proceed beyond a certain set of payments. A description of a payment channel implementation is outlined below.

Consider the scenario where Alice needs to pay Bob for a service. This may require multiple payments from Alice to Bob over a period of time as the situation demands. Alice expects to spend at most 15 BTC (in total) to Bob in the possible set of exchanges. To facilitate this, a payment channel is established between Alice and Bob and operates as follows:
Alice creates a 2-of-2 multisignature pay to script hash (P2SH) transaction, Tc, governed by both Alice and Bob that commits 15BTC originating from Alice. At this point the transaction is not submitted to the bitcoin network (such a multisignature address requires that 2 individuals (Alice and Bob) sign any transaction that spends money from this address);
Alice creates a separate refund transaction, T_{r,0}, returning all the funds from the ‘multisignature controlled funds’ to Alice. This transaction includes an nLockTime value of 100 blocks (nLockTime is a Bitcoin transaction parameter that allows a Bitcoin transaction to only be executable after a specified time has passed). Bob signs the transaction. This refund transaction allows Alice to be refunded, after nLockTime has transpired, if the exchange between Alice and Bob goes awry;
Alice signs the original transaction T_{c};
At this point Alice and Bob may proceed to create new refund transactions to reflect the (off the blockchain) payments being made from Alice to Bob. These refund transactions would reflect the net sum of money that Alice is required to pay Bob at that point in time. As an example, if Alice is to pay Bob 5BTC, a new refund transaction, T_{r,i}, is created that has an outputs sending 5BTC to Bob and 10BTC back to Alice. If Alice needs to pay another 5BTC to Bob then the new refund transaction, T_{r,i+1}, is created with outputs sending 10BTC to Bob and 5BTC to Alice. For each new refund transaction, assuming they are in agreement with the details, both parties sign the transaction but do not necessarily submit the transaction to the network;
Note that each successive refund transaction created has a lower nLockTime than that of the previous refund transaction;
nLockTime(T_{r,i+1})<nLockTime(T_{r,i});
If a user refuses to sign any T_{r,i} then an aggrieved user may simply submit the T_{r,i-1}. In the worst case scenario Alice signs T_{r,0} and submits it to the network reclaiming all her funds (after nLockTime has expired); and
The final refund transaction constructed represents the net sum of funds being transferred from Alice to Bob. This transaction is submitted to the network.

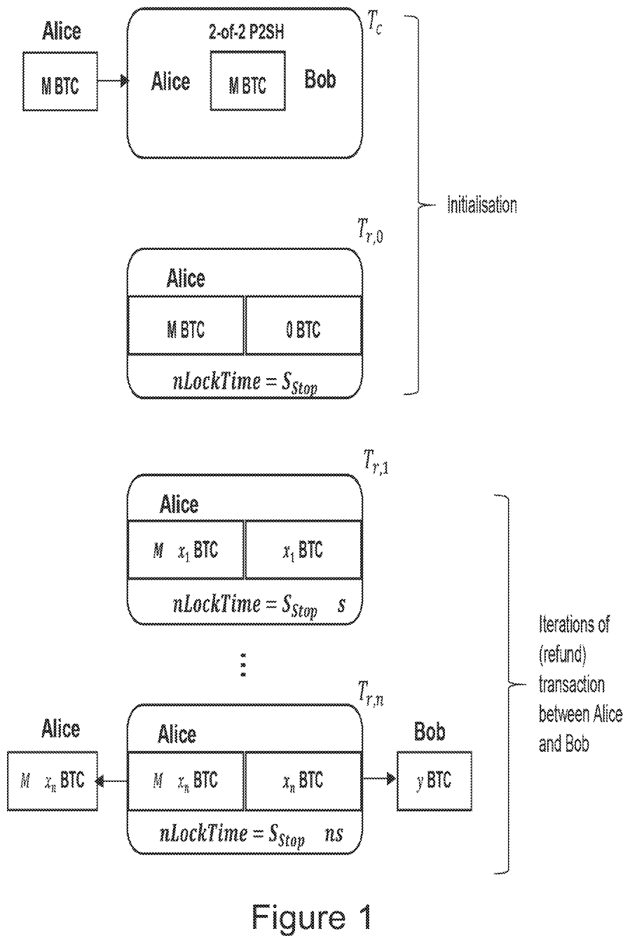

FIG. 1 shows the transactions used in a payment channel. M represents the maximum amount of money that may be sent from Alice to Bob. xᵢ is the current net sum of funds Alice needs to pay to Bob. Sₛₜₒₚ is the nLockTime on the initial refund transaction. n is the number of refund transactions created in the ongoing (off-block) payments made between Alice and Bob (this excludes the initial refund transaction). s is the time allotted for both users to agree to a refund transaction before a party risks the other party submitting the previous refund transaction, effectively ending the exchanges between Alice and Bob.

Note that:

t+n*s<Sₛₜₒₚ, where t is the current time, and

(Sₛₜₒₚ−n*s)≥s.

Transactions T_{c} and T_{r,n} of FIG. 1 are the transactions that appear on the blockchain.

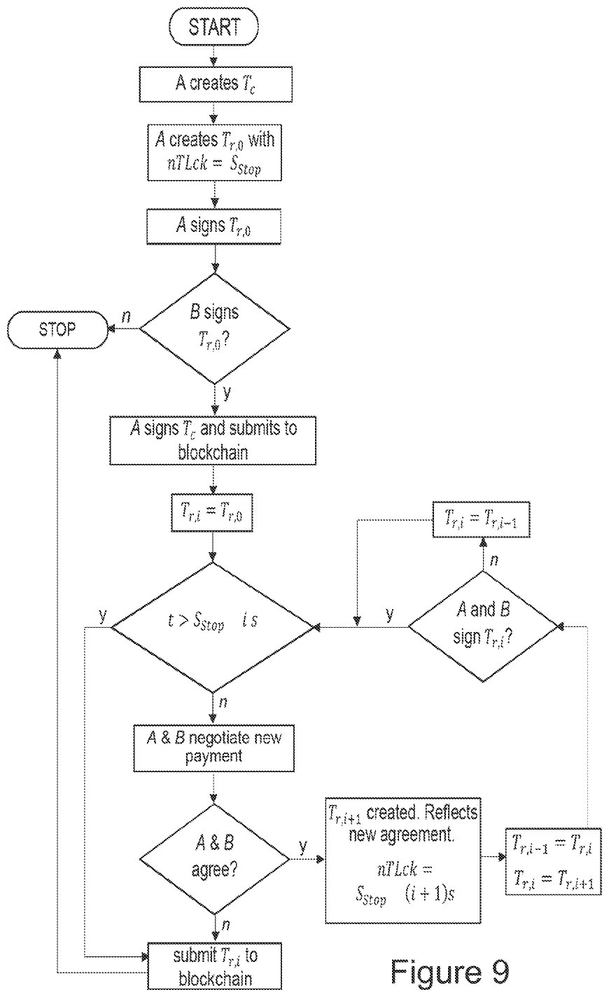

FIG. 9 shows a flow chart comprising steps involved in constructing the payment channel between Alice and Bob.

Atomic Cross-Chain Trading

For digital exchanges a “fair exchange” protocol is often necessary. The exchange represents a scenario where one user, UserA, is in possession of a value x and wants to exchange it for a value y owned by UserB. A fair exchange protocol allows the two users to either: (i) both honour and exchange; or (ii) neither honour and exchange. In Even, S. and Yacobi, Y., 1980. Relations among public key signature systems (Vol. 268). Technical Report 175, Technion, Haifa, Israel, (http://ftp cs.technion.ac.i1/users/wwwb/cgi-bin/tr-get.cgi/1980/CS/CS0175.pdf), it is shown that deterministic fair exchange is impossible without a trusted third party.

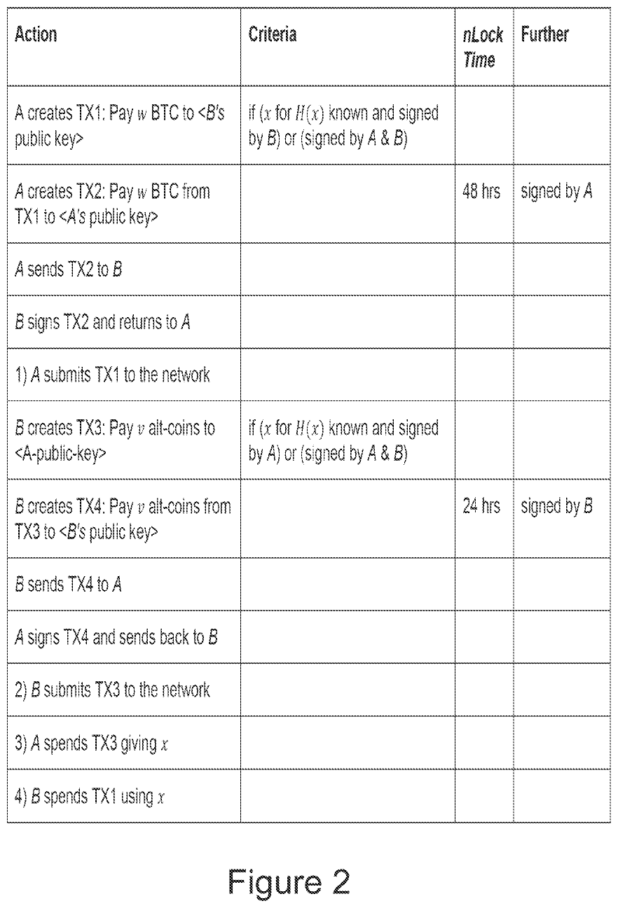

In the case of ACCT its authors devised a fair exchange protocol for two users to exchange coins across separate cryptocurrencies. For their solution the blockchains of the cryptocurrencies act as the trusted third party. An algorithm for ACCT is shown in FIG. 2, where Alice, A, pays w BTC to Bob, B, in exchange for v alt-coins.

This is ACCT (with timeout). If the process is halted, it can be reversed no matter when it is stopped.

With reference to FIG. 2, below is an example timeline of events during use of ACCT by users A and B:
Before 1): Nothing public has been broadcast, so nothing happens;
Between 1) and 2): A can use a refund transaction after 72 hours to get his money back;
Between 2) and 3): B can get a refund after 24 hours. A has 24 more hours to get his refund;
After 3): Transaction is completed by 2),
   A must spend his new coin within 24 hours or B can claim the refund and keep his coins;
   B must spend his new coin within 72 hours or A can claim the refund and keep his coins.

For safety, both A and B should complete the process with lots of time until the deadlines.

Group Random Exchange

The present invention relates to a Group Random Exchange (GRE) protocol. It provides a solution for the swapping of bitcoins within a group of n users where n>2. Each user in the group is able to swap an amount of bitcoins in their possession for the same amount of bitcoins.

However, without any change to the protocol, it is possible for the amount of bitcoins being exchanged between two users to not be equal. The value being exchanged between Uᵢ and U_{(1+1)mod n} may be any value the pair of users is able to negotiate between themselves.

Assuming x BTC is the agreed amount being exchanged, if desirable to all of the users affected, a user may pay (x+a) BTC whereas a user may withdraw (x-b) BTC. For example, a user U₁ has 10BTC for exchange. U₁ is willing to accept 8BTC from user U₀ if that is the best offer available to U₁. U₁ does this while understanding that it remains possible that further user U₂ will insist on receiving 10BTC. In other words, the value U₁ pays does not necessarily have to be the value U₁ is paid, if and only if U₁ accepts these terms, and the value U₁ pays may be the value U₁ is paid if U₁ insists.

From hereon, the description is limited for explanatory purposes only to the scenario where each user pays and is paid x BTC.

Furthermore, users may exchange tokens within the protocol. A token represents an asset or resource according to a smart contract associated with the token such that control of the token affords control of the asset or resource.

The net change in the bitcoins owned by a user does not change after participating in the exchange protocol, assuming transaction fees are ignored (transaction fees are costs associated with every Bitcoin transaction). Given a first user being UserA, UserA pays UserB the amount x BTC, UserC pays UserA x BTC, where UserB is not the same user as UserC. Additionally, each user has a source address associated with sending payments, and a receiving address associated with receiving payments, where the source address and receiving address are different. However, by participating in the protocol the user's bitcoins which were stored at a Bitcoin address are now in effect transferred to another address owned or controlled by the same user. Due to the exchange protocol processes, the transfer of bitcoins across addresses is accomplished in a way that obscures, in analysis of the blockchain, the transfer of funds.

The GRE protocol differs from ACCT in that ACCT only outlines a mutual exchange between a pair of users, whereas the GRE protocol describes an exchange where:
there are more than 2 users; and
in the process of being paid and paying, the second user a first user pays is not the user from whom the first user receives payment.

The GRE protocol achieves this in a way that:
users of the protocol are at no risk of losing their bitcoins; and
the second user who a first user pays is random, as is the user who pays the first user.

Group Random Exchange of the First Type—Secret Value

The group random exchange protocol operates in one of two ways, each embodying the present invention. A configuration of the present invention will now be described.

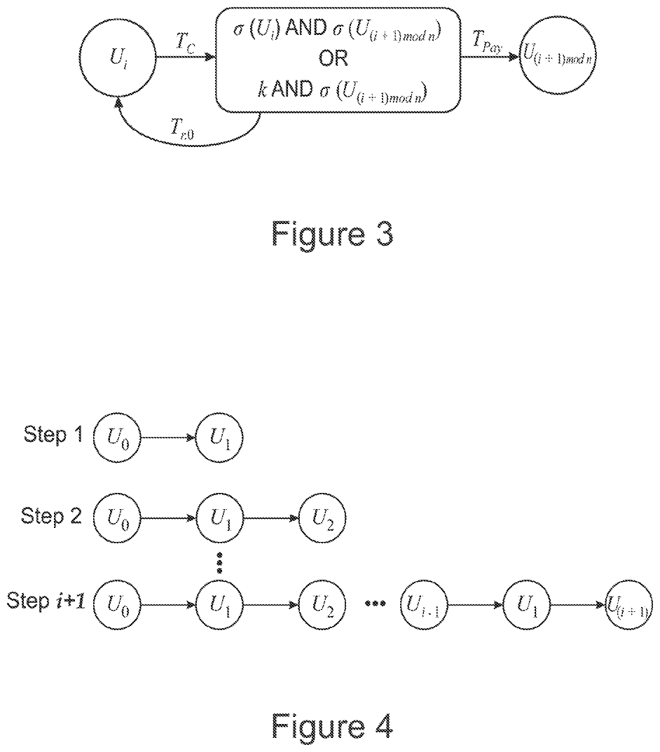

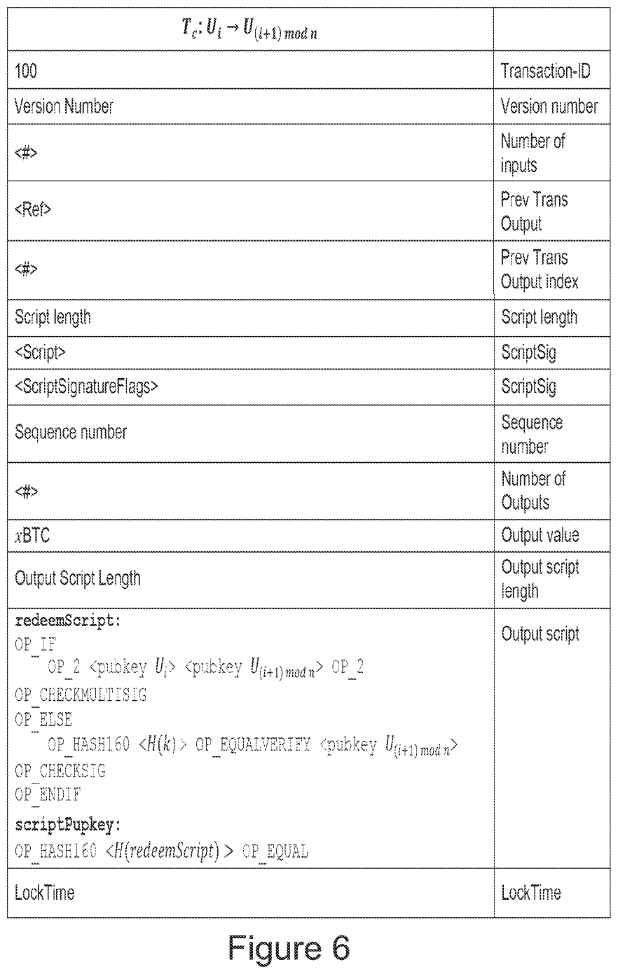

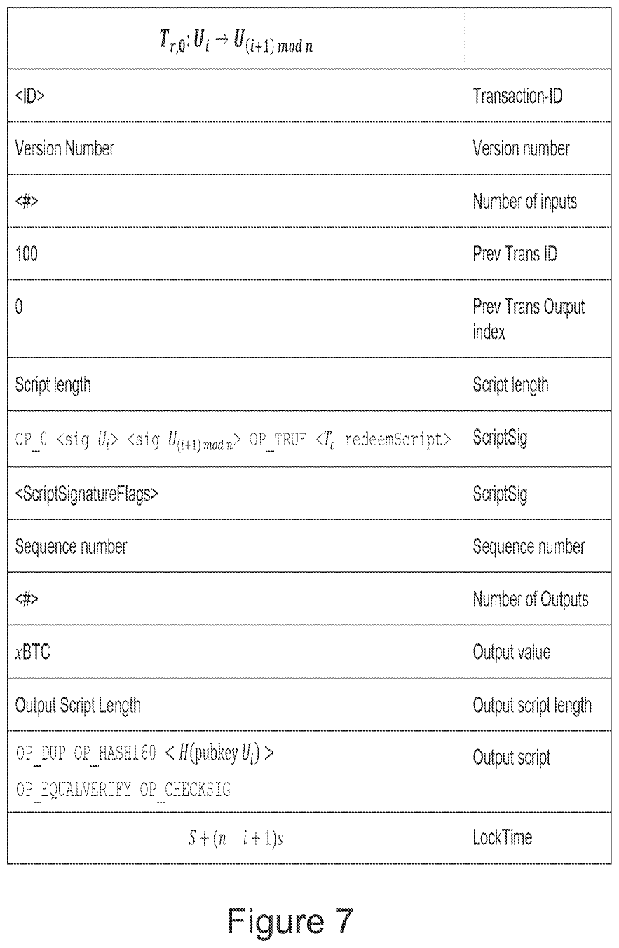

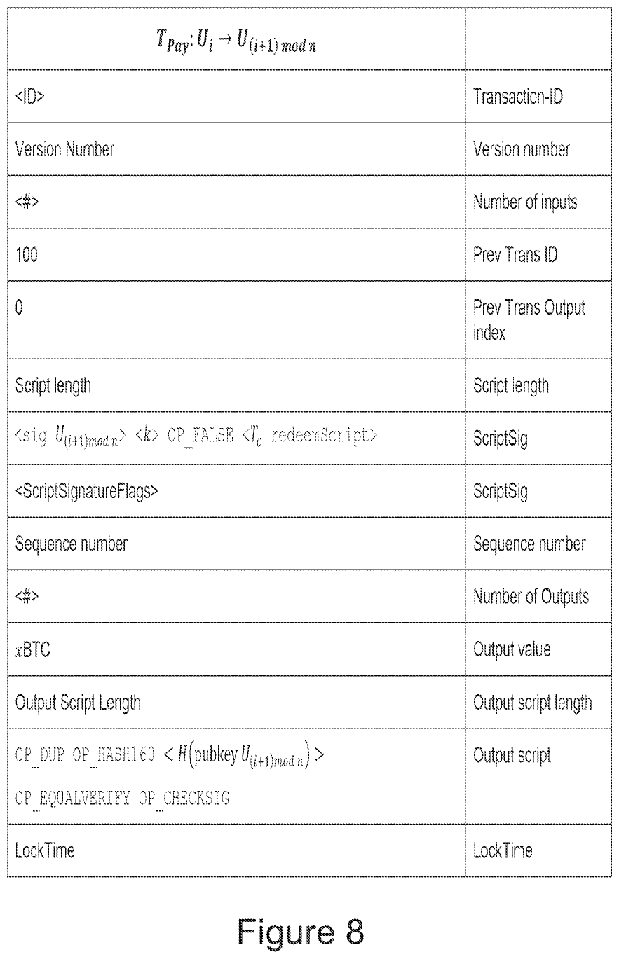

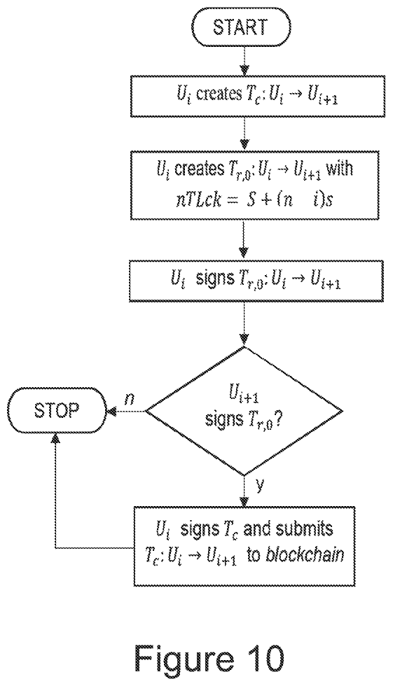

Given the interest of the set of n users Uᵢ|i∈[0, n−1] participating in the GRE protocol of a configuration of the present invention to swap x BTC, the protocol operates in the following way:
The users are randomized to realise an ordered set {U₀, U₁, . . . , Uₙ₋₂, Uₙ₋₁};
One of these users is deemed the ‘initiator’ or ‘initiating user’. For our purposes U₀ is considered the initiator;
The initiator U₀ chooses a random number k and calculates H(k) where H(·) represents a deterministic hash function;
The value of k is kept private by U₀ but the value H(k) is distributed to all users of the GRE;
A time value s is chosen that represents the amount of time each user Uᵢ is given to construct the payment channel Uᵢ→U_{(i+1)mod n}, retrieve the value of k, and submit execution transaction T_{pay} that pays U_{(i+1)mod n} to the Bitcoin network. Any user in the group may choose time s, given the consensus of the other users. In a preferred embodiment, the initiator chooses s to simply the protocol. Time s is expressed in either seconds or number of blocks;
Another value, S, is chosen as the starting time of the first payment to a user being submitted to the Bitcoin network. Any user in the group may choose S, given the consensus of the other users. In a preferred embodiment, the initiator chooses s to simply the protocol. Note that S represents a point in time specified in either Unix time or block height, whereas s represents a time span;
A one-way payment channel is established between every pair of users where the direction of the payment is such that Uᵢ pays U_{(i+1)mod n} (represented herein by Uᵢ→U_{(i+1)mod n}). As an example, assuming n=7, the payment channels of the GRE would consist of U0→U1, U1→U2, . . . , U6→U0.
The processes of the creation of a payment channel Uᵢ→U_{(i+1)mod n} are shown in FIGS. 3 and 10, wherein σ(Uᵢ) represents the signature of Uᵢ:
   the initial commitment transaction Tc makes available x BTC that can only be spent by providing either: (i) the signatures of both Uᵢ and U_{(i+1)mod n}; or (ii) k and the signature of U_{(i+1)mod n} (see FIG. 6 for reference);
   only one refund transaction is required here: refund function T_{r,0}, which returns all x BTC to U₁ (see FIG. 7 for reference);
   the refund transaction T_{r,0} contains an nLockTime value S+(n-i)s;
   The refund transaction T_{r,0} must be signed by U_{(i+1)mod n} before the initial commitment transaction Tc is submitted to the Bitcoin network;
   The payment channel contains a payment transaction T_{pay} which pays x BTC, from the committed x BTC of T_{c}, to U_{(i+1)mod n}; and
   the <scriptSig> for the payment transaction T_{pay} to U_{(i+1)mod n} contains within it value k (see FIG. 8 for reference);
It is important that the payment channels between pairs of users be created in an ordered sequence, in that the payment channel Uᵢ₋₁→Uᵢ is set up before the payment channel Uᵢ→U_{(i+1)mod n}. This begins with the creation of the first payment channel U₀→U₁ where U₀ is the initiator and ends with the last payment channel Uₙ₋₁→U₀. FIG. 4 illustrates the order of construction of the payment channels.

In some configurations, the order of the sequence is important as this allows user Uᵢ, before risking making their payment, to ensure that:
there exists a T_{pay} transaction to Uᵢ that requires only that Uᵢ has knowledge of k for transaction T_{pay} to be accepted by the Bitcoin network; and
the criteria found in the T_{pay} of the payment channel Uᵢ→U_{(i+1)mod n} (Uᵢ spends) are the same as that of T_{pay} of the payment channel Uᵢ₋₁→Uᵢ(Uᵢ receives).

Only the initiator U₀ does not have to prioritise receiving ahead of payment. However U₀ cannot be cheated as U₀ is the only user with knowledge of the value of k. Therefore no withdrawal can be performed by anyone in the GRE protocol until U₀ is comfortable starting the process (coinciding with its release of k).

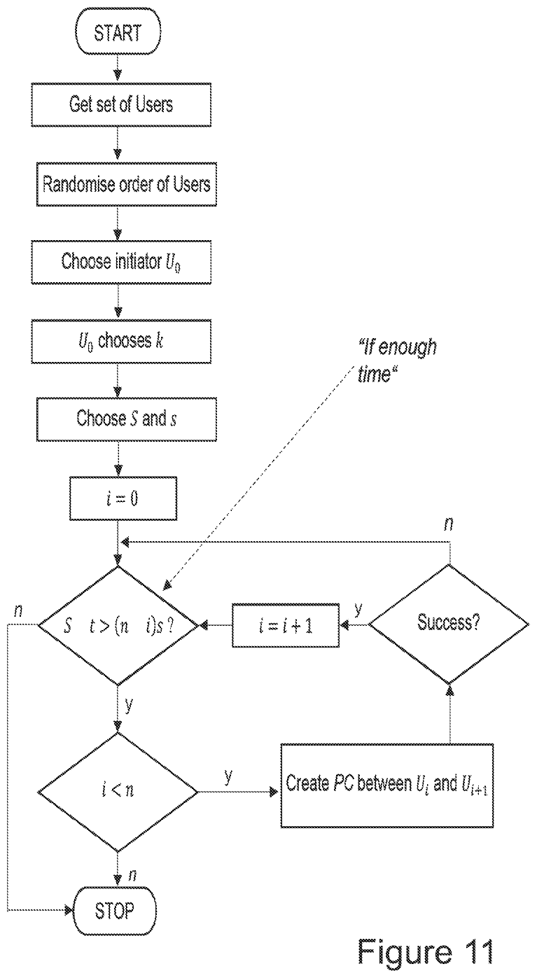

The processes of the creation of the set of Uᵢ→U_{(i+1)mod n} payment channels for a GRE instance are illustrated in FIG. 11.

It is assumed that the final payment channel Uₙ₋₁→U₀ is finalised at or before time S. Once this final payment channel is constructed, a chain of transactions, or a transaction chain, can be said to have been completed linking all of the users of the protocol.

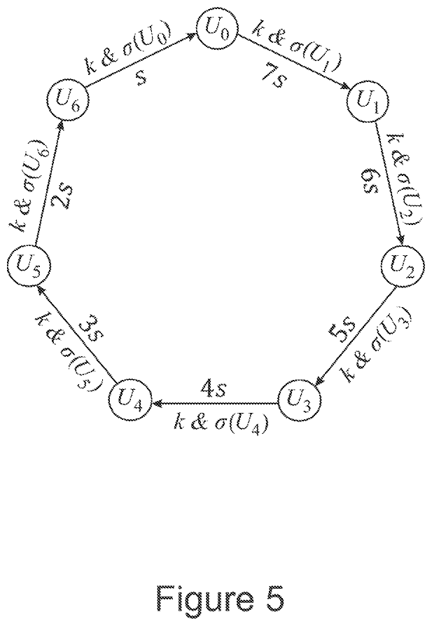

FIG. 5 illustrates a representation of the Uᵢ→U_{(i+1)mod n} payment channels existing between all users of the GRE protocol. Arrows signify the payment channels and direction of T_{pay} payment. Expressions externally adjacent the arrows represent the criteria for transaction T_{pay} to be accepted by the blockchain. Note that σ(Uᵢ) represents the signature of Uᵢ. Expressions internally adjacent the arrows represent the s time span values.

In light of the circular arrangement, the fact that the order of Uᵢ|i∈[0, n−1] was random means that the persons paying and paid by user Uᵢ are both random. Furthermore, the persons paying and paid by user Uᵢ are different.

The initiator U₀ spends the transaction T_{pay} of the existing payment channel Uₙ₋₁→U₀, revealing the value of k. U₀ can communicate this value of k directly to Uₙ₋₁ or this value may be retrieved from the blockchain.

Similarly each user Uᵢ may directly communicate the value k to its payer Uᵢ₋₁. If Uᵢ does not, user Uᵢ₋₁ may find the value in the blockchain ledger (within at least time s).

As the blockchain takes, at the time of filing this application, on average 10 minutes to confirm a transaction, the value of s should be chosen such that the time period it represents is sufficient for any user Uᵢ to find if necessary, within that time period, the value of k in a transaction T_{pay} (of the payment channel Uᵢ>U_{(i+1)mod n}) after the transaction is submitted to the Bitcoin network. The value of s should also include an estimated time for the construction of the payment channel between a pair of users. Therefore s may be chosen to be s=sₖ+ε where sₖ is the estimated time to find k and submit T_{pay} and ε is the estimated time to construct the payment channel.

As the initiating user U₀ has now submitted to the network the T_{pay} transaction of the existing payment channel between Uₙ₋₁ and U₀, revealing the value of k to Uₙ₋₁, the value of k can then be revealed to every other user Uᵢ in a reverse sequential way (from Uₙ₋₁ to U₂). This is based on the premise that each user, Uᵢ, will be invested in submitting the transaction (T_{pay} of the payment channel Uᵢ₋₁ to Uᵢ) that allows themselves to get paid. User Uᵢ submitting said transaction will require obtaining the value of k from T_{pay} of the payment channel Uᵢ to Uᵢ to Uᵢ₊₁ (which would have been made available previously). Through Uᵢ submitting that transaction T_{pay} of the payment channel Uᵢ₋₁ to U₁, the value of k is then made available to user Uᵢ₋₁. This process cascades all the way from Uₙ₋₁ to U₁ in such a way that each user Uᵢ cashing in reveals k to user Uᵢ₋₁, allowing the user Uᵢ₋₁ to also cash in.

More formally, the sequence of submission of T_{pay} transactions executing the payment channels occurs as follows:

[T_{pay}:Uₙ₋₁→U₀,[T_{pay}:Uₙ₋₂→Uₙ₋₁], . . . ,[T_{pay}:U₁→U₂],[T_{pay}:U₀→U₁]

Completion of the set of T_{pay} transactions successfully concludes the GRE. Each user paid x BTC and each user received x BTC.

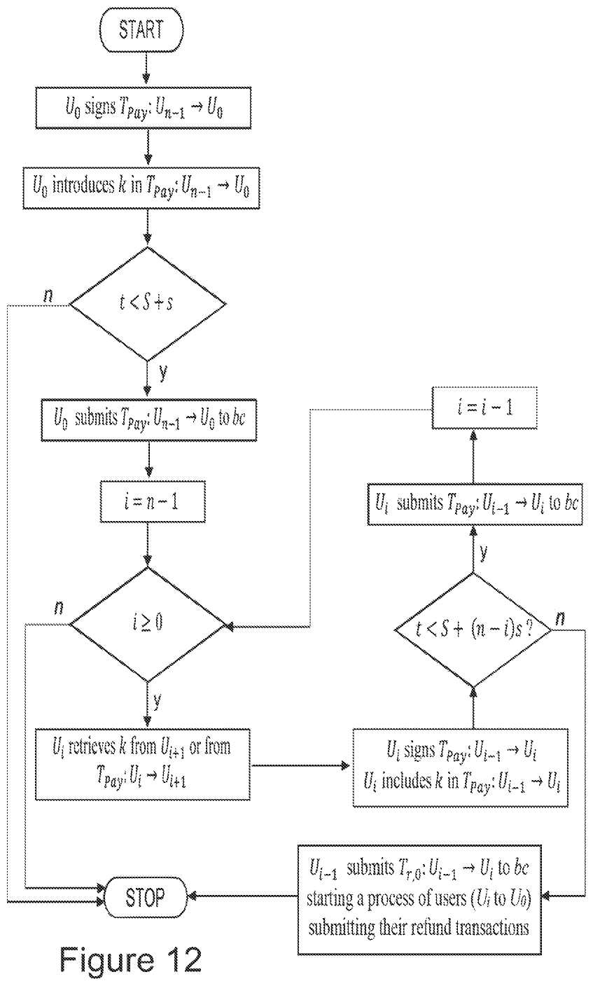

The processes of submitting the T_{pay}: Uₙ₋₁→U_{(i+1)mod n} transactions for a GRE instance are illustrated in FIG. 12.

Below, a description is given of the construction of the Bitcoin transactions utilised in the payment channel Uᵢ→U_{(i+1)mod n} between a pair of users. These payment channels comprise three main transactions:
Deposit into 2-of-2 multisignature Transaction T_{c}: This transaction represents the commitment component of the payment channel, and may be referred to as a commitment transaction. Here, through the transaction, user Uᵢ sends/commits a specified number of bitcoins, x BTC, to be governed by either:
   a 2-of-2 multisignature (Uᵢ, U_{(i+1)mod n})
   OR
   knowledge of a value k AND the signature of U_{(i+1)mod n};
Refund Transaction T_{r,0}: This transaction represents the refund of x BTC (from the commitment transaction) back to user Uᵢ after a specified time has expired. For this transaction to be executed successfully it requires the signatures of users Uᵢ and U_{(i+1)mod n}; and
Payment Transaction T_{pay}: This transaction is the payment of x BTC from to U_{(i+1)mod n}. For this transaction to be executed successfully it requires the knowledge of value k and the signature of U_{(i+1)mod n}. Payment transactions may also be referred to as execution transactions.

Note that while the details of the transaction are limited to the <scriptSig>, <scriptPubkey>, nLockTime, and output values of the various transactions, as these are most relevant to the GRE protocol described, other functions and values may be used.

Group Random Exchange of the Second Type—Changing Secret

A further configuration of the present invention will now be described.

In the case of the GRE protocol of the configuration described above, the value k being common for each of the payment channels may act as a limitation on the level of anonymity the GRE may provide to a user thereof. This is due to the fact that the shared use of k and/or its hash, H(k), makes it easier for an external observer to associate the set of transactions involved in that specific instance of a GRE. This reduces the observer's effort required to trace a user's movement of funds from one address to another.

In contrast to the configuration described above which uses the same secret value in all payment channels, the configuration described below uses a different secret value for each of the payment channels in the GRE exchange. Moreover, although the secret value is different for each channel, the revelation of the secret value when a transaction is submitted to the blockchain provides sufficient information for the subsequent revelation of the secret value in the next payment channel of the sequence.

To achieve this functionality, this configuration utilises the property of Elliptical Curve (EC) cryptography such that E(m)+E(n)=E(m+n); where E(x)=xG and G is a base point on the Elliptic Curve. However, other types of encryption having substantially similar homomorphic-like properties may be used in place of EC encryption.

An Elliptic Curve is the set of points described by the equation:

y²≡x³+ax+b(mod p);
where 4a³+27b²≢0 (mod p) and p is prime.

The EC Arithmetic functionality required inside Bitcoin script is that of point multiplication by scalar. This is the operation such that:

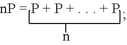

where n is a natural number, P is a point on the Elliptic Curve, and + is the operator for addition of points on the EC.

Scalar multiplication in turn requires the specific EC group operations Point Addition and Point Doubling:
Point Addition P+Q: With this operation, we compute a new point on the EC as a negation of the intersection of the curve. This can be described as R=P+Q,
Point Doubling P+P: Using point addition, we can compute a point double of P. This can be described as R=P+P=2P.

More specifically, given two points, P(x₁,y₁) and Q(x₂,y₂), on the EC:

$$P + Q = ( {x}_{3} , {y}_{3} ) ;$$

$$where :$$

$${x}_{3} = {m}^{2} - {x}_{1} - {x}_{2} mod p ;$$

$${y}_{3} = m ( {x}_{1} - {x}_{3} ) - {y}_{1} mod p ; and$$

$$m = \{ \begin{matrix}\frac{{y}_{2} - {y}_{1}}{{x}_{2} - {x}_{1}} mod p = if P \neq Q & ( Point Addition ) \\ \frac{3 {x}_{1}^{2} + a}{2 {y}_{1}} mod p : if P = Q & ( Point Doubling ) .\end{matrix}$$

As described above, the use of the value k (and in tandem H(k)), as criterion in each of the payment channels in the GRE circuit of the configuration using the same secret value in all payment channels, may prove to be a limitation as it relates to desire for anonymity.

If a user desires anonymity in the GRE exchange as it relates to the user's movement of bitcoins, it is expected that the address that U₁ pays x BTC from is different from the address that user receives x BTC into. This disconnect between addresses is meant to disassociate the payment and receipt transactions from each other in the Bitcoin blockchain.

However, an external observer with knowledge of the GRE protocol would know that Bitcoin transactions with scripts that contain a type of criteria are artefacts of an instance of a GRE. Moreover, since k and its hash are found within a subset of these GRE instances, the external observer would then be able to identify all transactions related to a specific instance of GRE, or at least drastically reduce the size of the set of possible transactions. While not guaranteeing success, this puts the external observer in a better position to track the movement of bitcoins in the GRE instance.

This configuration uses a GRE protocol wherein each payment channel uses a different unique secret value (sv) and a corresponding encrypted version of the secret value. It is to be noted that, in this configuration, hash functions themselves are not used but are replaced by EC encryption. This serves to reduce the ability for external observers to identify the set of transactions belonging to a specific GRE instance.

The different secret values of this configuration are expected to satisfy the following conditions:
a. The secret values should be difficult to guess;
b. The revelation of an sv_{(i+1)mod n} in executing T_{Pay} for the payment channel Uᵢ→U_{(i+1)mod n} should allow sv₁ of the next payment channel in GRE sequence Uᵢ₋₁→Uᵢ(anticlockwise) to be revealed or at least be easily calculable;
c. It should be difficult for external observers to identify a relationship between secret keys (or secret key encryptions (ciphertexts)); and
d. Users in the exchange should be at no risk of losing their funds.

It is possible to satisfy the previous criteria using EC encryption as a replacement of hash functions. For EC encryption a scalar value is multiplied by a base point G on the EC. The scalar value k is a secret key and Q=kG is the encrypted output. Determining k from Q is a ‘hard’ discrete logarithm problem.

Furthermore, for the addition operator of Elliptic Curve arithmetic, mG+nG=(m+n) G for a base point G.

This characteristic of EC cryptography allows for the revelation of another secret value, in sequence, for condition b.

Given a group of n users {U₁|i∈[0, n−1]} participating in the GRE protocol to swap x BTC, the protocol of this configuration of the present invention operates in the following way.
Users agree upon parameters (p,a,b,G,n,h) of Elliptic Curve Digital Signature Algorithm (ECDSA) curve. e. g. secp256k1;
The users are randomized to realise an ordered set
{U₀, U₁, . . . , Uₙ₋₂, Uₙ₋₂};
One of these users is deemed the ‘initiator’. For our purposes U₀ is considered the initiator;
The initiator U₀ chooses a random number kₛ and calculates kₛG where G represents the base point on the Elliptic Curve;
The value of kₛ is kept private by U₀;
Each of the other users U₁ to Uₙ₋₁ chooses a random number. U₁ selects k₁, U₂ selects k₂, . . . , and Uₙ₋₁ selects kₙ₋₁. Each of these other users securely send their chosen value to U₀. U₀ also chooses a second random number, k₀.
A time value s is chosen that represents the amount of time each Uᵢ is given to construct the payment channel Uᵢ→U_{(i+1)mod n}, retrieve the necessary secret value, and submit the execution transaction Tray that pays U_{(i+1)mod n} to the Bitcoin network. Time s is expressed as either seconds or number of blocks.
Another value S is chosen as the starting time of the first payment to a user being submitted to the Bitcoin network. Note that S represents a point in time specified in either Unix time or block height, whereas s represents a time span.

A one-way payment channel is established between every pair of users where the direction of the payment is such that Uᵢ pays U_{(i+1)mod n}. As an example, assuming n=7, the payment channels of the GRE would comprise U₀→U₁, U₁→U₂, . . . , and U₆→U₀.

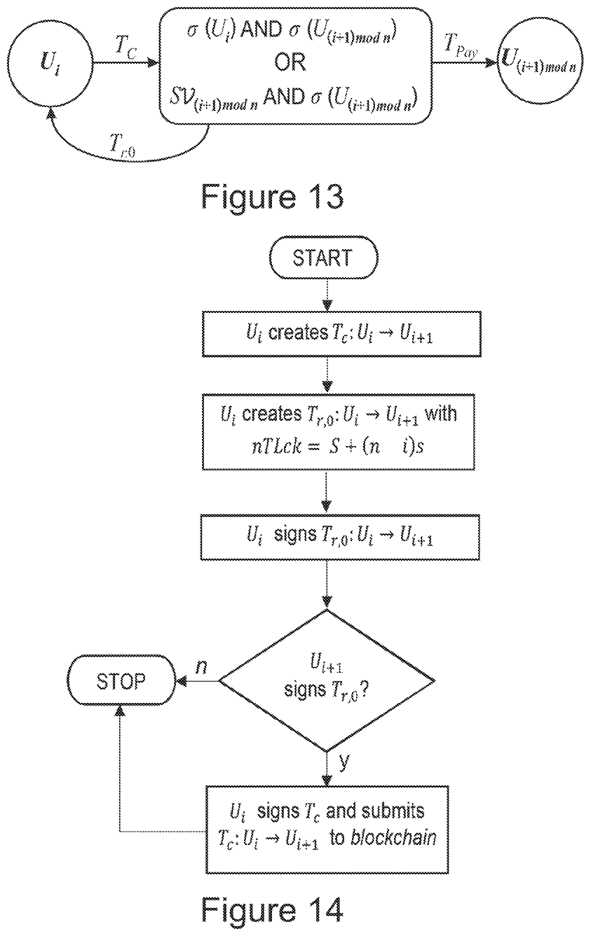

The processes of the creation of a payment channel Uᵢ→U_{(i+1)mod n} are described below and illustrated in FIGS. 13 and 14:
The initial commitment transaction T_{c} makes available x BTC that can only be spent, as per its <scriptPubkey>, by either ‘the signatures of both Uᵢ and U_{(i+1)mod n}’ OR ‘sv_{(i+1)mod n} AND signature of U_{(i+1) mod n}’;
There is only need for one refund transaction for our purposes; this refund transaction, T_{r,0} returns all x BTC to Uᵢ;
The refund transaction, T_{r,0}, of the payment channel contains an nLockTime value S+(n-i)s;
The refund transaction T_{r,0} must be signed by U_{(i+1)mod n} before the initial commitment transaction T_{c} is submitted to the Bitcoin network;
The payment channel contains a payment transaction T_{Pay} which pays x BTC, from the committed x BTC of T_{c}, to U_{(i+1)mod n}; and
The <scriptSig> for the payment transaction T_{Pay} to U_{(i+1)mod n}, is expected to contain within it a value sv_{(i+1)mod n}.

It is important that the payment channels between pairs of users be created in an ordered sequence, in that the payment channel Uᵢ₋₁→Uᵢ is set up before the payment channel Uᵢ→U_{(i+1)mod n}. This begins with the creation of the first payment channel U₀→U₁ where U₀ is the initiator and ends with the last payment channel Uₙ₋₁→U₀.

In some configurations, the order of the sequence is important as this allows user Uᵢ to, before making their payment and undertaking the risk associated with making the payment, ensure that there exists a T_{Pay} transaction to Uᵢ that Uᵢ is able to successfully execute if Uᵢ makes his/her T_{Pay} payment to U_{(i+1)mod n}.

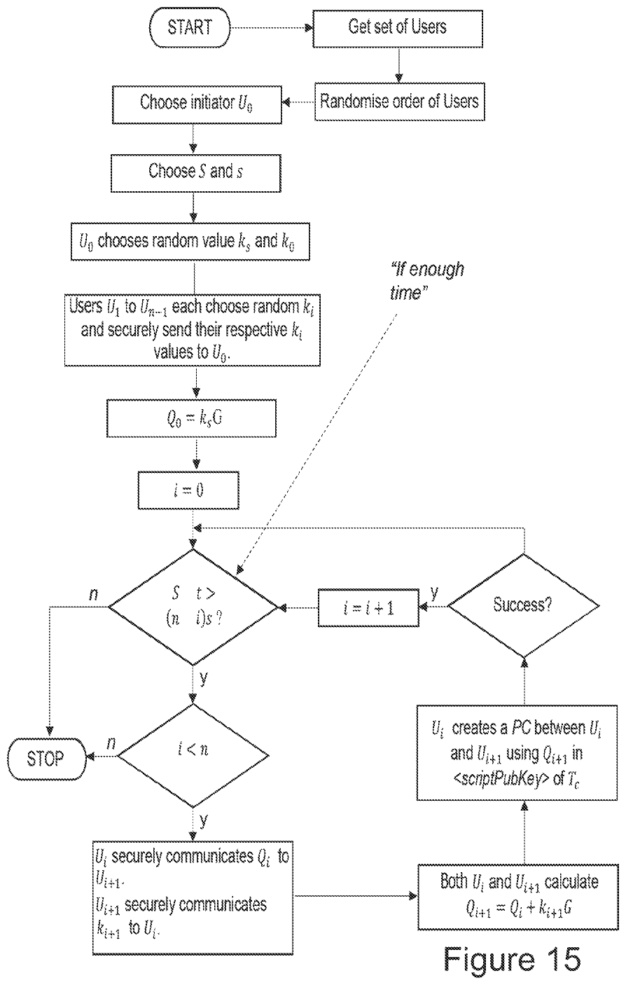

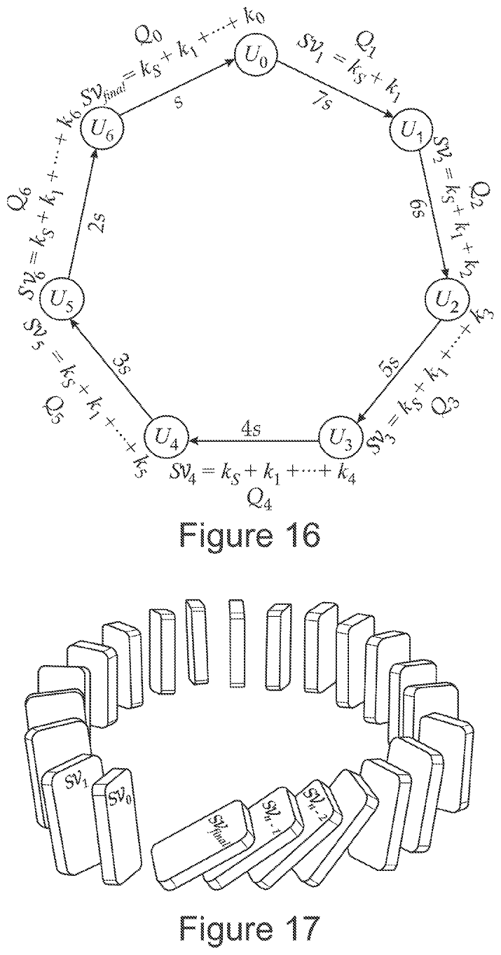

With reference to FIGS. 15 and 16, the preparation of the secret values used in this configuration will now be described.
1. The default value of the sv₀ is set as sv₀=kₛ. Recall that kₛ is a random value chosen by the initiator, U₀, in the GRE protocol list of users. This kₛ value is central to the security of the protocol, is known only to U₀, and kept secret until all payment channels are created and completed to the satisfaction of U₀;
2. U₀ encrypts the default sv value kₛ by multiplying it by the base point G of the Elliptic Curve. Where Qᵢ is the encrypted version of the svᵢ value, the encrypted version of the default sv is Q₀=sv₀G=kₛG;
3. For the first payment channel created, U₀→U₁, U₁ communicates its random number k₁ to U₀ and U₀ communicates the ‘encrypted version of the secret key,’ Q₀, to U₁;
4. The sv value for payment channel created, U₀→U₁, is to be sv₁=sv₀+k₁, for which its ciphertext is:

Q₁=Q₀+k₁G;
Noting that:
   The new secret value (kₛ+k₁) is present in the calculation of Q₁, given that:

Q₁=kₛG+k₁G=(kₛ+k₁)G;
user U₁ has no knowledge of kₛ and in tandem the secret value for the transaction; and
both U₁ and U₀ can calculate and verify the other's calculation of Q₁;
5. Steps 3 and 4 may be generalised for all other payment channels in the GRECS circuit. This generalisation is described below:
   U_{(i+1)mod n} communicates their random number k_{(i+1)mod n} to Ui. Uᵢ communicates the encrypted version of the secret key, Qᵢ, to U_{(i+1)mod n};
   The sv value for payment channel created is to be sv_{(i+1)mod n}=svᵢ+k_{(i+1)mod n}, for which its encrypted value is:

Q_{(i+1)mod n}=Qᵢ+k_{(i+1)mod n}G;
Noting that, for the payment channel:
   the new secret value sv_{(i+1)mod n}=kₛ+k₁+k₂+ . . . +k₁+k_{(i+1)mod n} can be seen in the calculation of Q_{(i+1)mod n}, given that:

$${Q}_{( i + 1 ) mod n} = {\underbrace{{k}_{s} G + {k}_{1} G + {k}_{2} G + … + {k}_{i} G}}_{{Q}_{i}} + {k}_{( i + 1 ) mod n} G$$

$$= ( {k}_{s} + {k}_{1} + {k}_{2} + … + {k}_{i} + {k}_{( i + 1 ) mod n} ) G ;$$

user U_{(i+1) mod n} has no knowledge of the secret value for the transaction as kₛ and all other previous iterations of sv have been encrypted; and
both U_{(i+1)mod n} and Uᵢ can calculate and verify the other's calculation of Q_{(i+1)mod n}.
Note that the previous processes apply also to the final payment channel Uₙ₋₁→U₀. As such, in addition to the secret random number kₛ, U₀ must also create a second random value k₀. k₀ is the final value added to the secret value. Note that the final secret value is labelled sv_{final} rather than sv₀; and
6. Only the initiator U₀ does not have to prioritise having the payment channel that pays him/her be established before the payment channel where he/she pays. This is because U₀ cannot be cheated as U₀ is the only person with knowledge of the value of kₛ which is required by all T_{pay} transactions of the all payment channels. Therefore no withdrawal can be done by any user of the GRE protocol of this configuration until U₀ is comfortable starting the process (coinciding with its release of the final secret value
   sv_{final}=kₛ+k₁+k₂+ . . . +kₙ₋₁+k₀, which includes the value of kₛ).

The final payment channel Uₙ₋₁→U₀ is finalised at or before time S. The set of payment channels connecting the users can be visualised as a circle as shown in FIG. 16, which shows a representation of the U₁→U_{(i+1)mod n} payment channels existing between all users of the protocol of this configuration. Arrows signify the payment channels and direction of T_{Pay} payment. Values externally adjacent the arrows represent the secret value required for the transaction T_{pay}: Uᵢ→U_{(i+1)mod n} to be accepted by the blockchain. Values internally adjacent the arrows represent the s time span values. The Qᵢ values represent the encrypted value of the payment channel's secret value.

In light of the circular arrangement, the fact that the order of {Uᵢ|I∈[0,n−1]} was random means that the user who pays a user Uᵢ is random and the user who Uᵢ pays is random. Likewise the user who pays a user Uᵢ is different from the user who Uᵢ pays.

The initiator U₀ spends the transaction T_{pay} of the existing payment channel Uₙ₋₁→U₀, revealing the value of sv_{final}=kₛ+k₁+k₂+ . . . +kₙ₋₁+k₀. As described above, it was U₀ who created the values kₛ and k₀, and all users were required to send their kᵢ values to U₀.

U₀ can communicate this value of sv_{final} directly to Uₙ₋₁, or this value may be retrieved from the blockchain.

Although Uₙ₋₁ now knows sv_{final}, this is not the secret value needed for Uₙ₋₁ to receive payment via the payment channel Uₙ₋₂→Uₙ₋₁:

sv_{final}=kₛ+k₁+k₂+ . . . +kₙ₋₁+k₀, whereas:

svₙ₋₁=kₛ+k₁+k₂+ . . . +kₙ₋₁.

However, Uₙ₋₁ may easily calculate svₙ₋₁ by subtracting k₀ from swami, then submit the T_{pay} transaction for their payment. Uₙ₋₁ would have known k₀ from previous processes in constructing the payment channel transactions.

Similarly each user U_{(i+1)mod n} may directly communicate the value sv_{(i+1)mod n} to its payer Uᵢ. If U_{(i+1)mod n} does not, user Uᵢ may retrieve the value sv_{(i+1)mod n} in the blockchain ledger (within at least time s).

From sv_{(i+1)mod n}, user Uᵢ can calculate svᵢ by subtracting k_{(i+1)mod n} from sv_{(i+1)mod n}. This allows Uᵢ to be paid via T_{Pay}: Uᵢ₋₁→Uᵢ.

As the blockchain takes on average 10 minutes to confirm a transaction, the value of s should be chosen such that the time period it represents is sufficient for any user Uᵢ to find if necessary, within that time period, the value of sv_{(i+1)mod n} in a transaction T_{pay}: Uᵢ→U_{(i+1)mod n}, after said transaction is submitted to the Bitcoin network. If the average time to confirm a transaction changes, then s can be chosen accordingly.

The value of s should also include an estimated time for the construction of the payment channel between a pair of users. Therefore s would be s=sₛᵥ+ε where sₛᵥ is the estimated time to find sv_{(i+1)mod n} and submit T_{pay}: Uᵢ→U_{(i+1)mod n}, and ε is the estimated time to construct the payment channel.

Due to the initiator U₀ having submitted to the network the T_{Pay} transaction of the existing payment channel between Uₙ₋₁ and U₀, revealing the value of sv_{final} to Uₙ₋₁, the value of svᵢ can then be revealed to every other user Uᵢ in an anticlockwise way (from Uₙ₋₁ to U₁): see FIG. 17. This is based on the premise that each user, Uᵢ, will be invested in submitting the transaction (T_{Pay} of the payment channel Uᵢ₋₁ to Uᵢ) that allows themselves to get paid.

User Uᵢ submitting said transaction will require obtaining the value of sv_{(i+1)mod n} from T_{Pay} of the payment channel Uᵢ to U_{(i+1)mod n} from which Uᵢ would derive svᵢ. Through Uᵢ submitting that transaction T_{pay} of the payment channel Uᵢ₋₁ to Uᵢ, the value of svᵢ is then made available to user Uᵢ₋₁ who then derives svᵢ₋₁. This process cascades like dominoes falling all the way from Uₙ₋₁ to U₁ in such a way that each user Uᵢ cashing in reveals the svᵢ₋₁ to user U₁-1, allowing the user Uᵢ₋₁ to also cash in.

More formally, the sequence of T_{Pay} transactions (executed/submitted) of the payment channels occurs as follows:

[T_{pay}:Uₙ₋₁→U₀],[T_{pay}:Uₙ₋₂→Uₙ₋₁], . . . ,[T_{pay}:U₁→U₂],[T_{Pay}:U₀ΘU₁],

Completion of the set of T_{Pay} transactions successfully concludes the process. Each user paid x BTC and each user received x BTC.

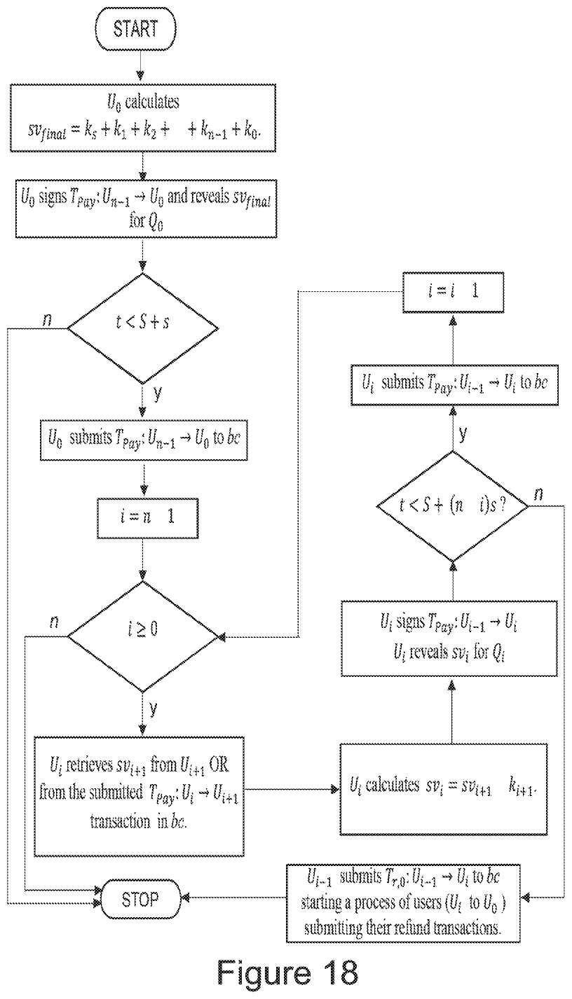

The processes of submitting the T_{pay}: Uᵢ→U_{(i+1)mod n} transactions in this configuration are illustrated in FIG. 18, wherein t is current time, PC is payment channel, Uᵢ₊₁=U_{(i+1)mod n}, and be is blockchain. For payment channel Uₙ₋₁→U₀, the sv value is named sv_{final}.

The submission of all refund transactions, T_{r,0}, to the blockchain is restricted by the nLockTime value. This value of the nLockTime parameter represents an absolute time value such that T_{r,0} will only be accepted by the blockchain at or after that time. The nLocktime value for Uᵢ→U_{(i+1)mod n} is S+(n-i)s.

A user Uᵢ submits T_{r,0}: Uᵢ→U_{(i+1)mod n} if U_{(i+1)mod n} fails to sign and reveal sv_{(i+1)mod n} for Q_{(i+1)mod n} before the nLocktime value.

If Uᵢ submits T_{r,0}:Uᵢ→U_{(i+1)mod n} this means that the payment transaction T_{Pay}: Uᵢ→U_{(i+1)mod n} has not been and will never be executed. This means that sv_{(i+1)mod n} will not revealed and thus Uᵢ₋₁ will not be able to calculate, from the blockchain, the svᵢ necessary for the payment transaction T_{Pay}: Uᵢ₋₁→Uᵢ.

Uᵢ₋₁ will have to wait till at or after the nLockTime value for Uᵢ₋₁→Uᵢ before submitting his refund transaction T_{r,0}: Uᵢ₋₁→Uᵢ.

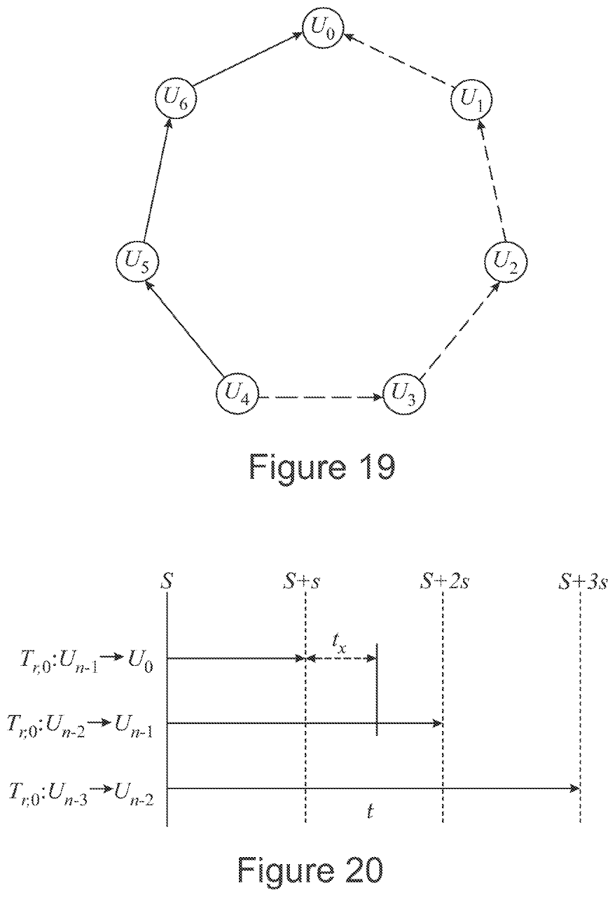

These refund submission processes are repeated, in an anticlockwise manner, for all users up to and including the initiator U₀ who submits T_{r,0}: U₀→Uᵢ. Each of these transactions can only occur at or after a specific point in time. An example of this sequence of refund transactions is shown in FIG. 19, wherein U₄ fails to sign and produce sv₄ for T_{Pay}: U₃→U₄ before t=S+4s. Refund transactions are represented by arrows pointing anticlockwise. Payment, or execution, transactions are represented by arrows pointing clockwise.

It is important to note that a refund transaction does not have to be submitted at the exact nLockTime value. It can be applied at that time or after. This means that while Uᵢ may grant U_{(i+1)mod n} extra time, tₓ, to sign and produce sv_{(i+1)mod n} for T_{Pay}: Uᵢ→U_{(i+1)mod n} this would mean that Uᵢ would consequently have less time to produce svᵢ for T_{Pay}: Uᵢ₋₁→Uᵢ (assuming Uᵢ is not granted extra time by Uᵢ₋₁). See FIG. 20, wherein U₀, given extra time tₓ, leads to Uₙ₋₁ having less time to calculate svₙ₋₁ and submit T_{Pay}: Uₙ₋₂→Uₙ₋₁ to the blockchain due to U₀'s late submission of T_{Pay}: Uₙ₋₁→U₀.

Below, a description is given of the construction of the Bitcoin transactions utilised in the payment channel UᵢU_{(i+1)mod n} between a pair of users of the protocol of this configuration. These payment channels are composed of three main transactions:
Deposit into 2-of-2 multisignature Transaction T_{c}: This transaction represents the commitment component of the payment channel, and may be referred to as a commitment transaction. Here, through the transaction, user Uᵢ sends/commits a specified number of bitcoins, x BTC, to be governed by either:
   a 2-of-2 multisignature (Uᵢ, U_{(i+1)mod n})
   OR
   knowledge of a value sv_{(i+1)mod n} AND the signature of U_{(i+1)mod n};
Refund Transaction T_{r,0}: This transaction represents the refund of x BTC (from the commitment transaction) back to user Uᵢ that becomes eligible for submission to the blockchain after a specified time has expired. For this transaction to be executed successfully it requires the signatures of users Uᵢ AND U_{(i+1)mod n}; and
Payment Transaction T_{Pay}: This transaction is the payment of x BTC from Uᵢ's committed funds to user U_{(i+1)mod n}. For this transaction to be executed successfully it requires the knowledge of a secret value sv_{(i+1)mod n} and the signature of the user U_{(i+1)mod n}. Payment transactions may also be referred to as execution transactions.

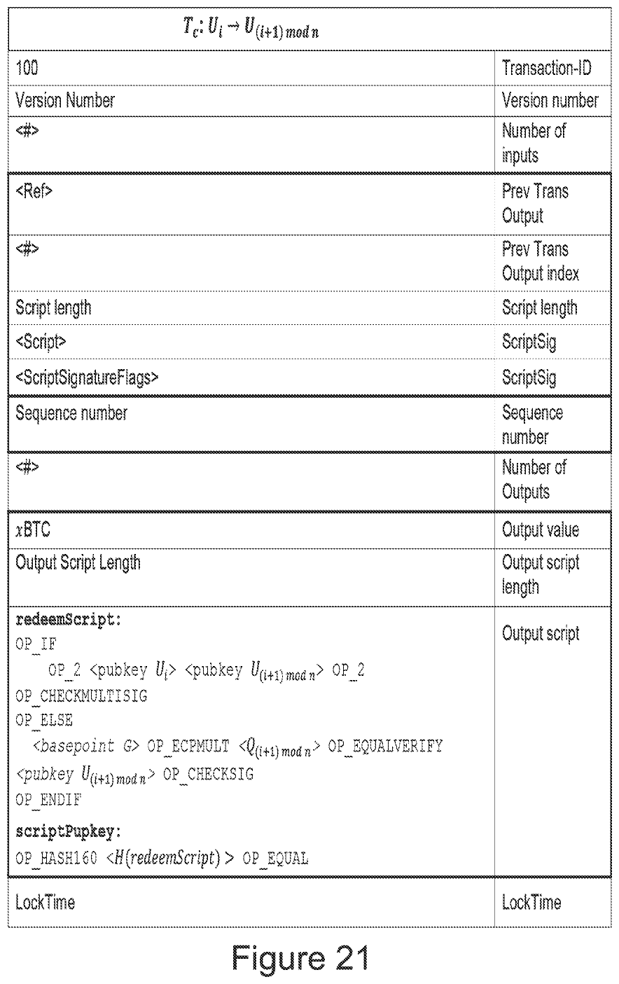

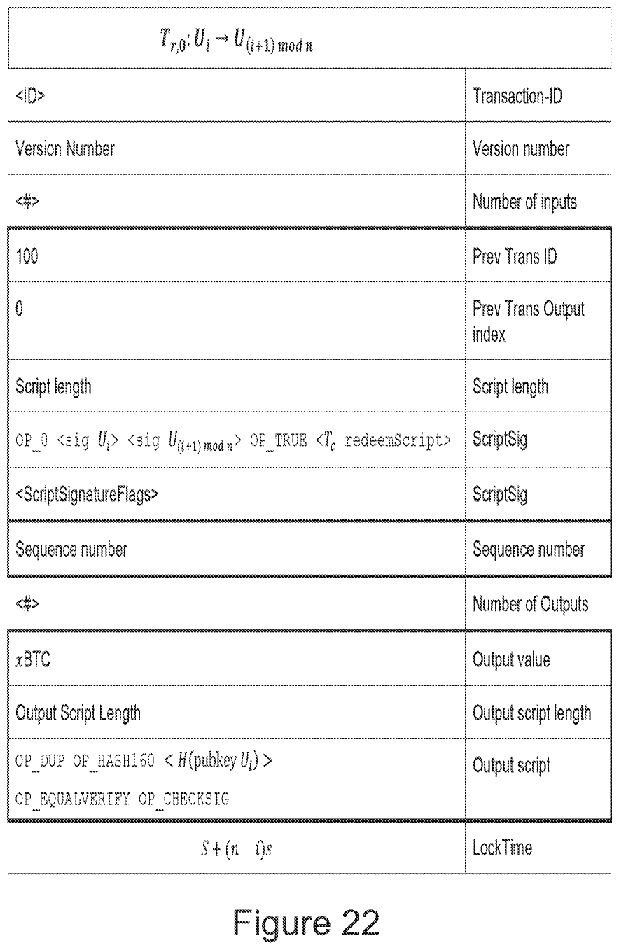

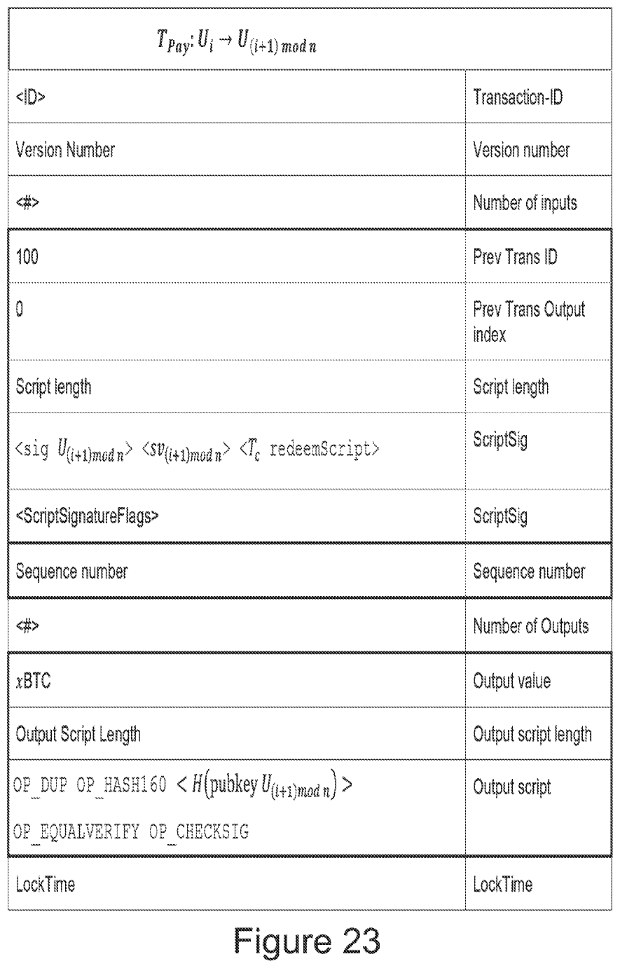

Note that the details of the transactions of FIGS. 21 to 24 are limited to the <scriptSig>, <scriptPubkey>, nLockTime, and output values of the various transactions, as these are the transaction elements most relevant to this configuration.

The transaction details are shown in FIGS. 21 to 24. Below, details of an Elliptic Curve opcode are described.

This configuration uses Elliptic Curve encryption. Given a secret value k, its EC encrypted value is Q=kG; where G is a base point on the Elliptic Curve.

This EC encryption serves as an equivalent of the hash function of the GRE of the configuration using the same secret value in all payment channels. However, the homomorphic-like property of EC addition enables a changing sv value in the payment channels of this configuration, while enabling the domino cascade of secret values starting with the reveal of the final version of sv, sv_{final}.

For each payment channel Uᵢ→U_{(i+1)mod n} the commitment transaction T_{c} includes a condition that stipulates that, apart from the refund, the committed funds can only be spent if the secret value sv_{(i+1)mod n} is presented that produces the encrypted value Q_{(i+1)mod n}. This non-refund spending of committed funds is to be done by the T_{Pay} of the payment channel.

Q_{(i+1)mod n}=sv_{(i+1)mod n}G

Where sv_{(i+1)mod n}=kₛ+k₁+k₂+ . . . kᵢ+k_{(i+1)mod n}

To determine if sv_{(i+1)mod n} is correct the following EC opcode is employed, which provides for the multiplication Q=kG. This opcode is called OP_ECPMULT. OP_ECPMULT takes an encoded Elliptic Curve Point and a number and performs Elliptic Curve Multiplication by Scalar. It outputs the result as an encoded Elliptic Curve Point.

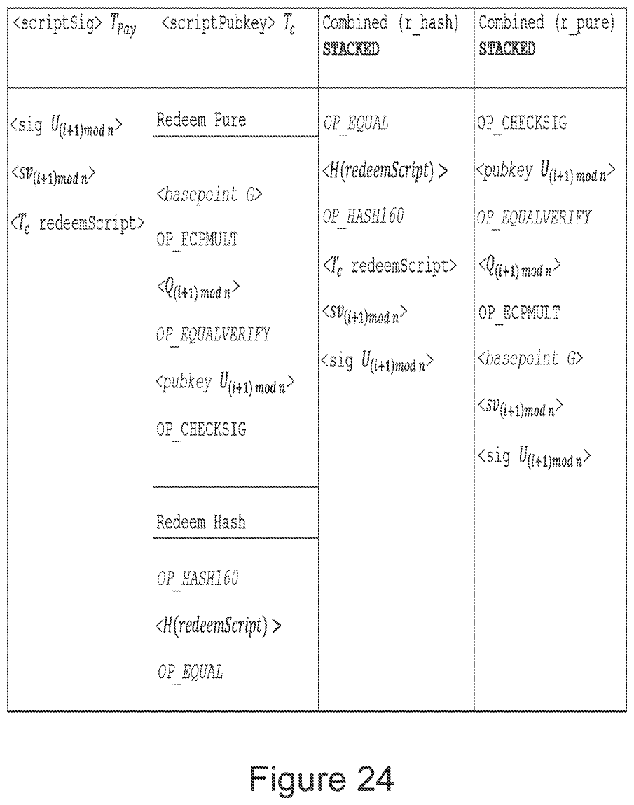

The scripts of the transactions T_{c}, T_{r,0}, and T_{Pay} of the payment channel Uᵢ→U_{(i+1)mod n} are shown in FIGS. 21 to 24. In particular, FIG. 24 shows how the <scriptPubKey> of the commitment transaction T_{c} is combined with the <scriptSig> of the payment transaction T_{Pay}, using the above-described opcode OP_ECPMULT, to unlock the committed x BTC.

Configurations of the present invention have been described above as using either the same secret value for all payment channels or different secret values for all payment channels, though it is within the remit of the skilled person to combine the configurations so as to use a combination of changing secret values and unchanging secret values.

Furthermore, it is to be understood that other communication channels, such as email, file transfer protocol, and peer-to-peer sharing may be used to communicate information by users of any configuration of the present invention, and that this information may relate to secret values or information relating thereto, details of one or more transactions, and complete or incomplete versions of one or more transactions themselves, and that the extent to which communication channels other than the Blockchain are used may depend on the level of trust existing between given pairs of users of the present invention.

It is to be understood that, while the configurations of the present invention described above refer only to the transfer of Bitcoins between users, that users may instead exchange other resources using the protocol, such as information, contracts, and tokens. A token represents an asset or resource according to a smart contract associated with the token, such that control of the token affords control of the asset or resource. The smart contract itself may be stored off-blockchain, or it may be stored inside one or more transactions.

Herein, the term “system” is used to encompass a system of computer hardware and/or software configured to carry out steps of at least one configuration of the GRE protocol described above, the protocol itself, and the protocol saved on computer hardware.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1-11. (canceled)

12. A computer-implemented method for participating in transaction mixing between a plurality of users on a blockchain comprising the steps of:
randomizing the plurality of users to realise an ordered set;
selecting one of a plurality of nodes as an initiator node;
by the initiator node, choosing a random number k and calculating H(k) where H(k) represents a deterministic hash function;
distributing H(k) to the plurality of users;
choosing a first time representing an amount of time each user is given to construct a payment channel Uᵢ→U_{(i+1)mod n}, retrieve a value of k, and submit an execution transaction T_{pay} that pays U_{(i+1)mod n} to a blockchain network of the blockchain;
choosing a second time starting when a payment to a user is submitted to the blockchain network; and
establishing a one-way payment channel between every pair of users in the ordered set to establish a transaction chain linking all the users.

13. The computer-implemented method of claim 12, wherein any user of the plurality of users chooses the first time and the second time, given a consensus of the other users.

14. The computer-implemented method of claim 12, wherein the initiator node chooses the first time and the second time.

15. The computer-implemented method of claim 12, wherein the first time is expressed in either seconds or a number of blocks and represents a time span.

16. The computer-implemented method of claim 12, wherein the second time is specified in either Unix time or block height.

17. The computer-implemented method of claim 12, wherein a direction of payment established by the one-way payment channels is such that Uᵢ pays U_{(1+1)mod_n} (represented herein by Uᵢ→U_{(i+1)mod_n}).

18. The computer-implemented method of claim 12, wherein a final payment channel Uₙ₋₁→U₀ is finalized at or before the second time.

19. The computer-implemented method of claim 12, wherein the initiator node spends the transaction T_{pay} of an existing payment channel Uₙ₋₁→U₀, revealing the value of k.

20. A system comprising:
one or more processors; and
memory storing computer-executable instructions that, if executed, cause the one or more processors to perform a method for participating in transaction mixing between a plurality of users on a blockchain comprising the steps of:
randomizing the plurality of users to realize an ordered set;
selecting one of a plurality of nodes as an initiator node;
by the initiator node, choosing a random number k and calculating H(k) where H(k) represents a deterministic hash function;
distributing H(k) to the plurality of users;
choosing a first time representing an amount of time each user is given to construct a payment channel Uᵢ→U_{(i+1)mod n}, retrieve a value of k, and submit an execution transaction T_{pay} that pays U_{(1+1)mod n} to a blockchain network of the blockchain;
choosing a second time value S starting when a payment to a user is submitted to the blockchain network; and
establishing a one-way payment channel between every pair of users in the ordered set to establish a transaction chain linking all the users.

21. The system of claim 20, wherein any user of the plurality of users chooses the first time and the second time, given a consensus of the other users.

22. The system of claim 20, wherein the initiator node chooses the first time and the second time.

23. The system of claim 20, wherein the first time is expressed in either seconds or a number of blocks and represents a time span.

24. The system of claim 20, wherein the second time is specified in either Unix time or block height.

25. The system of claim 20, wherein a direction of payment established by the one-way payment channels is such that Uᵢ pays U_{(1+1)mod n} (represented herein by Uᵢ→U_{(i+1)mod n}).

26. The system of claim 20, wherein a final payment channel Uₙ₋₁→U₀ is finalized at or before the second time.

27. The system of claim 20, wherein the initiator node spends the transaction T_{pay} of an existing payment channel Uₙ₋₁→U₀, revealing the value of k.
